(19) United States
(12) Patent Application Publication
(10) Pub. No.: US 2010/0207832 A1
(43) Pub. Date: Aug. 19, 2010

(54) ANTENNA ARRANGEMENT, PRINTED CIRCUIT BOARD, PORTABLE ELECTRONIC DEVICE & CONVERSION KIT

(75) Inventors: Zhinong YING, Lund (SE); CheckChin Yong, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/428,160

(22) Filed: Apr. 22, 2009

Related U.S. Application Data
(60) Provisional application No. 61/153,153, filed on Feb. 17, 2009.

(51) Int. Cl. H01Q 1/36

(52) U.S. Cl. 343/749; 343/700 MS

(57) ABSTRACT

An antenna arrangement including a first antenna branch and a second antenna branch having a common feed point is provided. The first antenna branch includes a first conducting portion, a second conducting portion, and a first gap between the first and second conducting portions, and a plurality of inductor elements is connected in parallel across the first gap.

### TECHNICAL FIELD

The present invention generally relates to an antenna arrangement, a printed circuit board, a portable electronic device, such as a mobile telephone, incorporating such an antenna arrangement and/or printed circuit board, and an antenna arrangement conversion kit.

### BACKGROUND OF THE INVENTION

An antenna is a transducer designed to transmit and/or receive radio, television, microwave, telephone, and/or radar signals, i.e., an antenna converts electrical currents of a particular frequency into electromagnetic waves and vice versa. Physically, an antenna is an arrangement of one or more electrical conductors that is arranged to generate a radiating electromagnetic field in response to an applied alternating voltage and the associated alternating electric current, or that can be placed in an electromagnetic field so that the field will induce an alternating current in the antenna and a voltage between its terminals.

Portable electronic devices, such as mobile phones, typically include an antenna that is connected to electrically conducting tracks or contacts on a printed circuit board (PCB) by soldering or welding. Manufacturers of such electronic devices are under commercial pressure to reduce the physical size, weight, and cost of the devices and to improve their electrical performance. These requirements dictate that the electronic device and its antenna should be simple and inexpensive to manufacture and assemble, and should occupy as little of the space available in the electronic device as possible.

It is also desirable for manufacturers to provide an electronic device with a versatile antenna capable of simultaneously transmitting and/or receiving signals using different wireless communication standards, such as GSM (Global System for Mobile communications), UMTS (Universal Mobile Telecommunications System) and frequencies of 700-960 MHz and 1.7-2.7 GHz, i.e. a dual- or multi-band antenna. Accordingly, an antenna is typically provided with a tuning unit that matches a transceiver with a fixed impedance to a load (feed line and antenna) impedance which is unknown, complex and/or otherwise does not match, so that the antenna may be used to receive and/or transmit a broad range of frequencies.

An antenna's impedance, however, may be affected by other factors, such as how the electronic device containing the antenna is being held (the so-called “head and hand effect”). For example, when users hold their head and/or hands near an antenna radiator, the antenna is namely detuned, causing mismatch at the intended operating frequency. If a relatively large metallic component, such as a speaker, is placed in the vicinity of an antenna, this may also degrade the operating performance of the antenna.

### SUMMARY OF THE INVENTION

An embodiment of the present invention may provide a versatile antenna that is suitable for dual- and/or multi-band applications.

According to one embodiment, an antenna arrangement may include a first antenna branch and a second antenna branch having a common feed point. The first antenna branch may include a first conducting portion, a second conducting portion, and a first gap between the first and second conducting portions. The first conducting portion may extend from the feed point to a first side of the first gap, and the second conducting portion may extend from the second side of the first gap to the end of the first antenna branch. A plurality of inductor elements may be connected in parallel across the first gap. The inductance of the inductor elements may be chosen so that a resonance frequency of the antenna arrangement corresponds to an operating frequency thereof and/or for size reduction, filtering and matching, and antenna efficiency improvement purposes. The inductor elements can therefore be arranged to create multiple resonances with good, reliable bandwidth.

Such an antenna arrangement has been found to significantly improve the antenna performance, i.e., antenna efficiency and bandwidth, Total Radiated Power (TRP), and Total Isotropic Sensitivity (TIS). The antenna arrangement is of a compact design and alleviates the above-mentioned head and hand effect, even if a metallic component (RF-lossy material), such as a speaker is placed in the vicinity of the antenna arrangement, since the antenna arrangement may be arranged at the bottom of (top is possible as well) a portable electronic device. Furthermore, such an antenna arrangement requires little to no matching and/or switching circuits, which leads to a reduction in manufacturing costs, time, and complexity. Matching and/or switching circuit, however, are also possible.

According to an embodiment of the invention the second antenna branch may include a first conducting portion, a second conducting portion, and a second gap between the first and second conducting portions, whereby a plurality of inductor elements is connected in parallel across the second gap. It should be noted that the second antenna branch need not necessarily include a gap and a plurality of inductor elements connected in parallel across the gap. The second antenna branch can be removed in various arrangements, for example, if the antenna feed is located in a corner of the substrate that supports it.

According to another embodiment of the invention, the first antenna branch may be longer than the second antenna branch and/or of a substantially the same length.

According to a further embodiment of the invention, the second conducting portion of the first antenna branch may include a plurality of conducting paths, optionally of different lengths.

According to an embodiment of the invention, the second conducting portion of the first antenna branch may include, at least in part, a meandering conducting path, such as a line-shaped meander pattern and/or a spiral conducting path, i.e. the second conducting portion may include a plurality of different parts and any part thereof may be arranged so as to increase the length of the conducting portion per unit length of the substrate that supports it.

According to another embodiment of the invention, the antenna arrangement may include a ground point and a parasitic radiator branch connected to the ground point. The parasitic radiator branch may enhance the reception of lower band signals and/or upper band signals. As such, the antenna arrangement may produce a wider usable bandwidth and a better receiving ability than an antenna without such features. The parasitic radiator branch may be directly connected to a ground point, allowing the antenna arrangement to retain relatively small dimensions and to be particularly suitable for use in a portable device.

According to a further embodiment of the invention, the antenna arrangement may include a ground point and a conducting path connected between the ground point and anywhere along the first antenna branch, for matching purposes. Such a conducting path may be used to simultaneously create low band resonance and/or high band resonance. It should be noted that a “ground point” need not necessarily be a point, but can even be a surface or at least part of a component of an electronic device containing the antenna arrangement, and/or a plane, for example. It should be noted that the antenna arrangement according to the present invention may include any number of the ground points.

According to an embodiment of the invention, the inductor elements are wire wound elements having at least one coil or chip inductor or any other kind of inductors, or any other passive electrical component that can store energy in a magnetic field created by the electric current passing through it.

According to an embodiment of the invention the antenna arrangement is arranged to transmit and/or receive frequencies in one or more and/or each of the following particular frequency ranges: 700-800 MHz; 824-894 MHz; 880-960 MHz; 1710-1850 MHz; 1820-1990 MHz; 1920-1990 MHz; 1920-2170 MHz; and/or 2500-2700 MHz.

It should be noted that the plurality of inductor elements may be marketed as an integral part of an antenna arrangement and/or as part of a kit that can be used to convert an antenna arrangement so as to be suitable for dual- or multi-band applications and/or further dual- or multi-band applications. For example, a conversion kit including at least one conducting portion and a plurality of inductor elements connected in parallel may be provided to users to enable existing antenna arrangements to be converted so that an electronic device containing the antenna arrangement may be able to receive and/or transmit signals of one or more different particular frequencies. Such a kit may, for example, be printed on a substrate, such as a SIM card, that may be removably implemented in a mobile telephone when its user travels abroad to a country having a different wireless communication standard, for instance. Alternatively, such a kit may be permanently connected to an antenna arrangement.

The present invention also relates a printed circuit board (PCB) that may include an antenna arrangement according to any of the embodiments of the invention.

The present invention further relates to a portable electronic device that includes an antenna arrangement and/or a PCB according to any of the embodiments of the invention. The portable electronic device may be a mobile communication device, such as a mobile telephone, in which the antenna arrangement is particularly arranged at the bottom of the mobile communication device when it is in use in order to optimize the talk-position performance, including antenna efficiency, TRP, TIS, and/or Specific Absorption Rate (SAR), Hearing Aids Compatibility (HAC), and unavoidably, to reduce the above-mentioned head and hand (shielding) effect. It is, however, also possible to arrange the antenna arrangement at the top of, or anywhere else in, a mobile communication device.

### BRIEF DESCRIPTION OF THE DRAWINGS

The present invention will hereinafter be further explained by means of non-limiting examples with reference to the appended figures, in which:

FIGS. 1a and 1b schematically show two antenna assemblies according to embodiments of the invention;

FIG. 2 schematically shows a first antenna branch of an antenna assembly according to different embodiments of the invention;

FIG. 3 schematically shows a printed circuit board according to an embodiment of the invention;

FIG. 4 schematically shows a portable electronic device according to an embodiment of the invention; and

FIG. 5 shows a optimized matching topology for an antenna assembly according to an embodiment of the present invention.

It should be noted that the drawings have not been drawn to scale and that the dimensions of certain features have been exaggerated for the sake of clarity and ease of explanation.

### DETAILED DESCRIPTION OF EMBODIMENTS

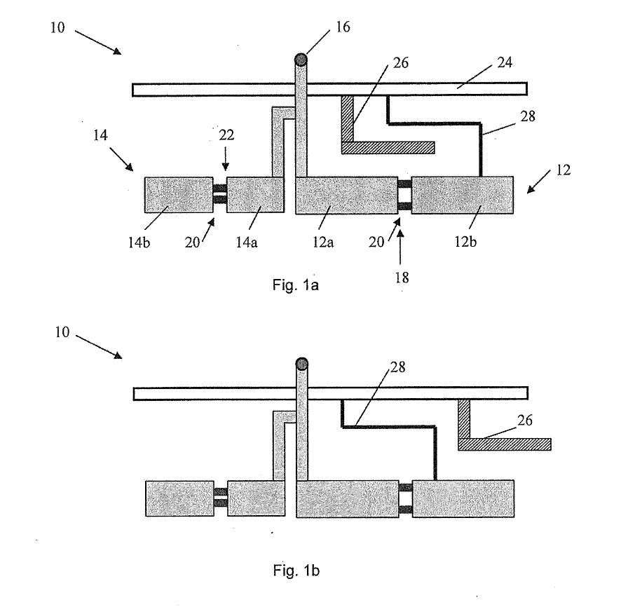

FIG. 1a shows an antenna arrangement 10 according to an embodiment of the invention. Antenna arrangement 10 may include a first longer antenna portion or branch 12 for both low band and high band, and a second shorter antenna portion or branch 14 for high band and/or low band, having a single common feed point 16 that is arranged to feed a current to one end of first and second antenna branches 12, 14. First antenna branch 12 may include a first conducting portion 12a, a second conducting portion 12b, and a first gap 18 between first and second conducting portions 12a, 12b, whereby a plurality of inductor elements 20 is connected in parallel across first gap 18, so as to connect first and second conducting branches 12a, 12b of the first antenna branch 12. Inductor elements 20 may, for example, function as a low pass filter and thereby prevent high frequency signals from crossing first gap 18.

Inductor elements 20 may be wire-wound elements having at least one coil or chip inductor and/or any other kind of inductor, which are etched directly onto a PCB and/or substrate associated with antenna arrangement 10. First and second antenna branches 12, 14 may include an electrically conducting film which is disposed on a substrate and/or PCB comprising a dielectric material, for example.

Only two of inductor elements 20 have been shown in the illustrated example, however, antenna arrangement 10 may include any particular number of inductor elements 20 to connect across first gap 18. The accompanying claims recite a plurality of inductor elements, since use of multiple inductor elements have been found to substantially improve the performance of an antenna arrangement in a manner in which a single inductor element connected across a gap does not.

Second antenna branch 14, in the illustrated embodiment, may include a first conducting portion 14a, a second conducting portion 14b, and a second gap 22 between first and second conducting portions 14a, 14b, whereby a plurality of inductor elements 20 is connected in parallel across second gap 22. It should be noted that second antenna branch 14 need not necessarily include a gap and/or a plurality of inductor elements connected in parallel across any gap provided. Furthermore, second antenna branch 14 may be routed in any suitable direction and not necessarily in the manner shown in FIGS. 1a and 1b. Second antenna branch 14 can be removed, for example, if the antenna feed is located in the corner of the substrate from which it is supported.

Antenna arrangement 10 may include a ground point (and/or plane) 24, such as a conductor film disposed on a surface of a substrate supporting antenna arrangement 10, and a parasitic radiator branch 26 connected to ground point 24. A conducting path 28 may provide a connection between ground point 24 and first antenna branch 12. It should be noted that antenna arrangement 10 may include an additional parasitic branch that may either be grounded, connected to a feed, and/or function as a third antenna branch. The particular length of the additional parasitic branch may be selected based on a resonance frequency that it is desired to improve and its presence may provide an additional parameter to better control the matching, for example.

Such an antenna arrangement may be combined with an optimized LC matching topology to realize a seven-band matched antenna. Such an antenna arrangement may namely be arranged to transmit and/or receive frequencies in up to and including seven bands having the following particular frequencies (in MHz), for example: 700-800; 824-894; 880-960; 1710-1850; 1820-1990; 1920-1990; 1920-2170; and/or 2500-2700. Antenna arrangement 10 may be relatively compact since the particular distance between ground plane 24 and the end of first antenna branch 12 may be selected to be minimal. A component, such as a metal plate and/or PCB underneath the antenna arrangement, may be used as a ground plane, and such an antenna arrangement may thus be included in a thin and compact and/or miniaturized electronic device, such as a mobile telephone.

FIG. 1b shows an alternative embodiment of the antenna arrangement shown in FIG. 1a, in which the particular positions of conducting path 28 and/or parasitic radiator branch 26 have been interchanged.

Antenna arrangement 10 shown in FIGS. 1a and 1b is merely an example of an antenna arrangement structure. Antenna arrangement 10, for example, may be formed as a U-shaped structure, whereby first and second antenna branches 12, 14 may be selectively arranged to extend across top/bottom edges and/or side edges of a PCB, for example, whereby components, such as an audio speaker and/or camera, may be disposed inside the U-shaped antenna arrangement structure.

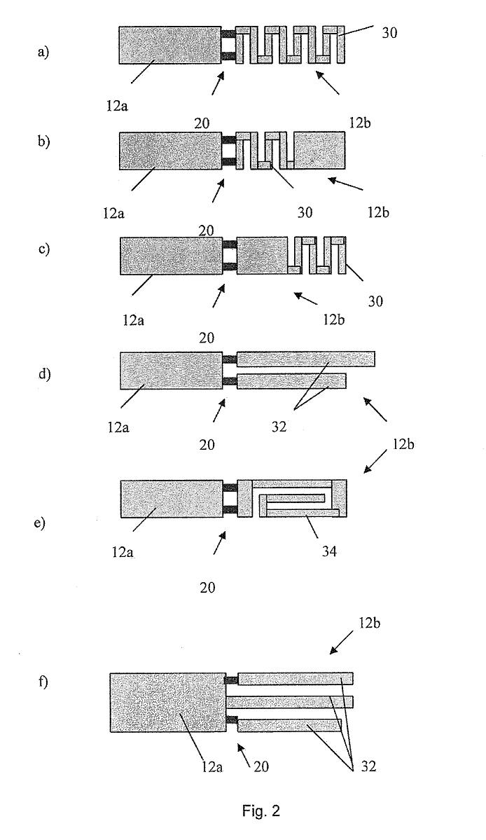

The first and/or second conducting portions of first and second antenna branches 12, 14 need not necessarily be straight line conductors. FIG. 2 shows different embodiments of first antenna branch 12 of antenna arrangement 10, according to embodiments of the present invention. Second conducting portion 12b of first antenna branch 12 may include, at least in part, a meandering conducting path 30, such as a line-shaped meander pattern and/or a saw-tooth shaped pattern, as shown in FIGS. 2a-2c, so as to increase the length of second conducting portion 12b per unit length of the supporting substrate. Alternatively and/or additionally, second conducting portion 12b of first antenna branch 12 may include a plurality of conducting paths 32, as shown in FIG. 2d, one or more of which may be of different lengths and/or of a same length, and which may be of any form, such as line-shaped and/or meandering. Furthermore, second conducting portion 12b of first antenna branch 12 may include, at least in part, a spiral conducting path 34, as shown in FIG. 2e. FIG. 2f shows an embodiment in which first antenna branch 12 includes second conducting portion 12b in the form of a plurality of conducting paths 32, in which inductor elements 20 are connected in parallel across gaps between first conducting portion 12a and two of conducting paths 32 of second conducting portion 12b, in the illustrated embodiment.

It should be noted that first conducting portion 12a of first antenna branch 12 may be of any form, for example, it may, at least in part, include a serpentine conducting path.

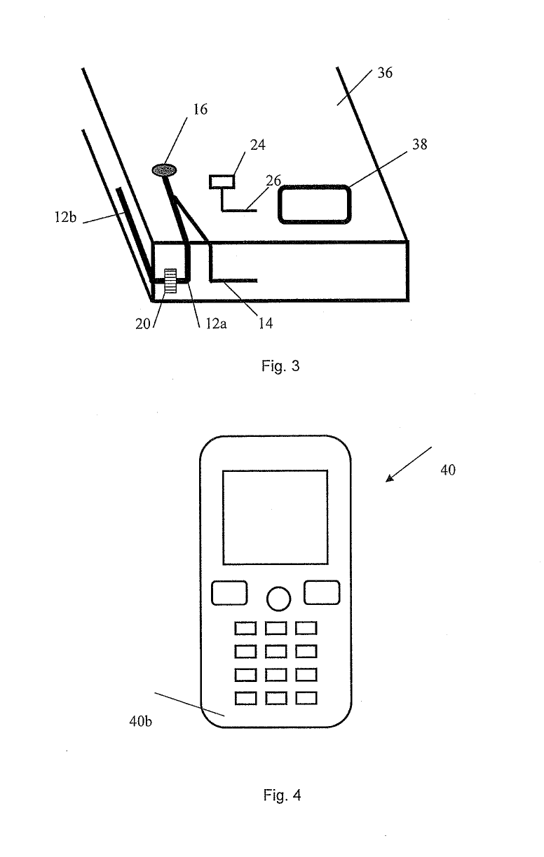

FIG. 3 shows how antenna arrangement 10, according to an embodiment of the invention, may be incorporated into and/or arranged on a printed circuit board (PCB) 36. First antenna branch 14 may extend from feed point 16 along a top surface of PCB 36, a first side surface of PCB 36, and then a second side surface of PCB 36. Second antenna branch 14 may extend from feed point 16 along a top and a side surface of PCB 36. As illustrated, antenna arrangement 10, may include parasitic radiator branch 26 connected to ground point 24 of antenna arrangement 10. Antenna arrangement 10 may be located in the vicinity of an audio speaker 38. It should be noted that antenna branches 12, 14 and/or any portion thereof (e.g., 12a, 12b, 14a, and/or 14b) need not necessarily be folded or bent at all, or folded or bent, as illustrated in FIG. 3.

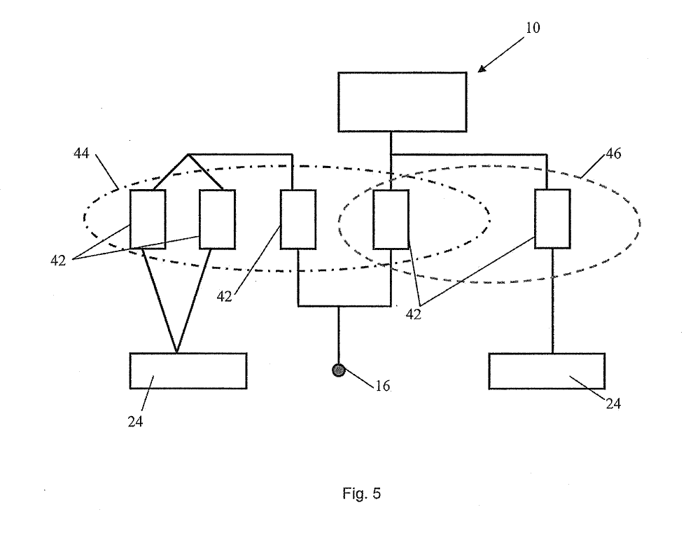

FIG. 4 shows a portable electronic device 40, a mobile telephone, for instance, which may include integrated antenna arrangement 10 and/or printed circuit board 36, according to an embodiment of the invention. Antenna arrangement 10 may be arranged at a bottom 40b of mobile telephone 40, such that that the performance of antenna arrangement 10 is not adversely affected due to shielding by a user when mobile phone 40 is in use.

FIG. 5 shows an optimized matching topology for antenna assembly 10 according an embodiment of the present invention. A plurality of inductor and/or capacitor components 42 may be connected between antenna arrangement 10, common feed point 16 of antenna arrangement 10, and/or ground points 24, as shown in FIG. 5. A high frequency chassis mode exciting network 44 may be used to excite the high frequency chassis mode and a low frequency chassis mode exciting network 46 may be used to excite the low frequency chassis mode. Extra modes may therefore be created below and/or above a resonance frequency of antenna arrangement 10 in a compact manner.

Further modifications of the invention within the scope of the claims would be apparent to a person skilled in the relevant art.

What is claimed is:

1. An antenna arrangement comprising:
a first antenna branch including:
a first conducting portion,
a second conducting portion, and
a first gap between the first and second conducting portions;
a second antenna branch; and
a feed point common to the first and second antenna branches, where a first plurality of inductor elements is connected in parallel across the first gap.

2. The antenna arrangement of claim 1, where the second antenna branch comprises:
a first conducting portion,
a second conducting portion, and
a second gap between the first and second conducting portions, where a second plurality of inductor elements is connected in parallel across the second gap.

3. The antenna arrangement of claim 1, where the first antenna branch is as least as long as the second antenna branch.

4. The antenna arrangement of claim 1, where the second conducting portion of the first antenna branch comprises a plurality of conducting paths.

5. The antenna arrangement of claim 4, where the plurality of conducting paths are of varying lengths.

6. The antenna arrangement of claim 1, where the second conducting portion of the first antenna branch comprises a meandering conducting path.

7. The antenna arrangement of claim 1, where the second conducting portion of the first antenna branch comprises a spiraling conducting path.

8. The antenna arrangement of claim 1, further comprising:
a ground point; and
a parasitic radiator branch connected to the ground point.

9. The antenna arrangement of claim 1, further comprising:
a ground point; and
a conducting path connected between the ground point and the first antenna branch.

10. The antenna arrangement of claim 1, where the first plurality of inductor elements comprises wire-wound elements having at least one coil or chip inductor.

11. The antenna arrangement of claim 1, where the antenna arrangement is configured to transmit and/or receive frequencies in at least one of 700-800 MHz; 824-894 MHz; 880-960 MHz; 1710-1850 MHz; 1820-1990 MHz; 1920-1990 MHz; 1920-2170 MHz; or 2500-2700 MHz frequency ranges.

12. The antenna arrangement of claim 1, where the antenna arrangement is implemented in a printed circuit board.

13. The antenna arrangement of claim 1, where the antenna arrangement is implemented in a portable electronic device.

14. The antenna arrangement of claim 13, where the portable electronic device comprises a mobile telephone.

15. The antenna arrangement of claim 14, where the antenna arrangement is arranged at a bottom of portion the mobile telephone from a perspective of a user of the mobile telephone.

16. A kit for converting an antenna arrangement to enable dual- or multi-band applications or additional dual- or multi-band applications, where the kit comprises:
a conducting portion; and
a plurality of inductor elements connected in parallel, where the inductor elements are configured to be connected to a conducting portion of an antenna branch of the antenna arrangement.
